(19) United States
(12) Patent Application Publication
(10) Pub. No.: US 2026/0106332 A1
(43) Pub. Date: Apr. 16, 2026

(54) BUSBAR ASSEMBLY

(71) Applicant: SK On Co., Ltd., Seoul (KR)

(72) Inventors: Dae Gyun HWANG, Daejeon (KR); Hui Jun SHIN, Daejeon (KR); Hoe Wook CHOI, Daejeon (KR); Chong Pyo HONG, Daejeon (KR)

(21) Appl. No.: 19/359,688

(22) Filed: Oct. 16, 2025

(30) Foreign Application Priority Data
Oct. 16, 2024 (KR) 10-2024-0141416

(51) Int. Cl. H01M 50/503; H01M 50/507; H01M 50/211

(52) U.S. Cl. CPC H01M 50/503; H01M 50/507; H01M 50/211

(57) ABSTRACT

The present disclosure relates to a busbar assembly comprising: a plurality of busbars each including one or more through holes formed therein for inserting a plurality of electrode tabs, and a busbar frame including a plurality of receiving portions on which the plurality of busbars are each mounted, wherein a bottom surface of the receiving portion includes one or more through holes being opened at a position corresponding to the through holes when the busbar is mounted.

### CROSS-REFERENCE TO RELATED PATENT APPLICATION

The present application claims priority under 35 U.S.C. § 119a to Korean patent application number 10-2024-0141416 filed on October 16, 2024, in the Korean Intellectual Property Office, the entire disclosure of which is incorporated by reference herein.

### BACKGROUND OF THE DISCLOSURE

### 1. Field

This disclosure relates to secondary batteries, and more specifically, to a busbar assembly.

### 2. Description of the Related Art

The demand for secondary batteries, which serve as energy power sources for various electronic devices such as smartphones, laptops, vehicles, and drones, is rapidly increasing. In particular, research on battery modules is actively underway for secondary batteries used to power vehicles.

A battery module may include multiple battery cells. Through the busbar assembly of the battery module, multiple battery cells can be electrically connected. A battery cell may represent the smallest unit of a battery.

The busbar assembly may include an internal busbar that electrically connects battery cells within the battery module, and an external busbar that electrically connects the battery cells to external devices. The internal busbar and external busbar may be connected to each other through welding.

The busbar assembly fixes the busbars and busbar frames through heat fusion; however, heat fusion may break during the heat fusion process, necessitating management of the heat fusion points.

To eliminate the need for thermal fusion and its associated damage, and to improve the quality and reduce the cost of the busbar assembly, a new assembly structure is required.

The present disclosure provides a busbar assembly with a new assembly structure.

### SUMMARY OF THE DISCLOSURE

A busbar assembly according to an embodiment of the present disclosure may comprise: a plurality of busbars each including one or more through holes formed therein for inserting a plurality of electrode tabs, and a busbar frame including a plurality of receiving portions on which the plurality of busbars are each mounted, wherein a bottom surface of the receiving portion includes one or more through holes being opened at a position corresponding to the through holes when the busbar is mounted.

In an embodiment, the busbar may be inserted from the front of the receiving portion and mounted on the busbar frame.

In an embodiment, the busbar frame may further include a plurality of walls formed between each of the plurality of receiving portions.

In an embodiment, the wall may further include a first guide groove guiding a side of the busbar and extending in a width direction of the busbar frame.

In an embodiment, the busbar frame may further include a second guide groove guiding a side of the busbar on an inner side of the busbar frame and extending in a width direction of the busbar frame.

In an embodiment, the busbar frame may further include one or more openings being opened to expose a portion of each mounted busbars.

In an embodiment, each length of the openings may be smaller than a length in the length direction of the receiving portion.

In an embodiment, the receiving portion may further include a protrusion protruding from the bottom surface.

In an embodiment, the busbar may further include a groove for receiving the protrusion.

In an embodiment, the receiving portion may further include a hook portion protruding from the bottom surface and being bent toward the rearward direction of the receiving portion.

In an embodiment, the busbar may further include an opening through which the hook portion passes.

In an embodiment, the busbar may include a plate.

In an embodiment, the receiving portion may include a slit.

The embodiments of the present disclosure may provide a busbar assembly with a new type of assembly structure.

The embodiments of the present disclosure may eliminate the heat fusion process, thereby preventing thermal deformation and damage of the busbar assembly caused by heat fusion.

The embodiments of the present disclosure may improve a quality of the busbar assembly by eliminating the heat fusion process.

The embodiments of the present disclosure may provide a design freedom for the busbar assembly.

Meanwhile, the present disclosure can be widely applied to electric vehicles, battery charging stations, energy storage systems ESS, and other green technology fields such as photovoltaics and wind power using battery cells. In addition, the electrode assembly according to the present disclosure and the battery cell including the same can be used for eco-friendly mobility and the like including electric vehicles and hybrid vehicles for preventing climate change by suppressing air pollution and greenhouse fluid emission.

### BRIEF DESCRIPTION OF THE DRAWINGS

FIG. 1 illustrates a battery module according to an embodiment.

FIG. 2 illustrates a busbar assembly according to an embodiment.

FIG. 3 illustrates a battery cell according to an embodiment.

FIG. 4 illustrates the assembly of the busbar assembly according to an embodiment.

FIG. 5 illustrates a busbar frame according to an embodiment.

FIG. 6 is a perspective view illustrating the busbar frame according to an embodiment.

FIG. 7 is a bottom view illustrating the busbar according to an embodiment.

FIG. 8 is a sectional view illustrating the combination relationship between the busbar and the busbar frame according to an embodiment.

FIG. 9 illustrates a busbar frame according to another embodiment.

FIG. 10 is a bottom view illustrating the busbar according to another embodiment.

FIGS. 11A and 11B are cross-sectional views illustrating the combination relationship between the busbar and the busbar frame according to another embodiment.

### DETAILED DESCRIPTION

Hereinafter, with reference to the attached drawings, the preferred embodiments of the present disclosure will be described in order to explain the busbar assembly according to various embodiments of the present disclosure.

Before the description, when it is stated that a part "includes" or “comprise” a component, this means that it may include other components unless otherwise specified.

Additionally, in multiple embodiments, components with the same configuration will be represented using the same reference numerals in one embodiment and described in detail, while other embodiments will only describe the components that differ from the described embodiment.

The structural or functional descriptions of the embodiments disclosed in this specification or application are provided solely for the purpose of illustrating embodiments of the technical concept disclosed herein. Embodiments of the technical concept disclosed herein may be implemented in various forms other than the embodiments disclosed in this specification or application, the technical concept of this disclosure is not limited to the embodiments described in this specification or application.

The following figures provide a more detailed description of the busbar assemblies according to various embodiments of the present disclosure.

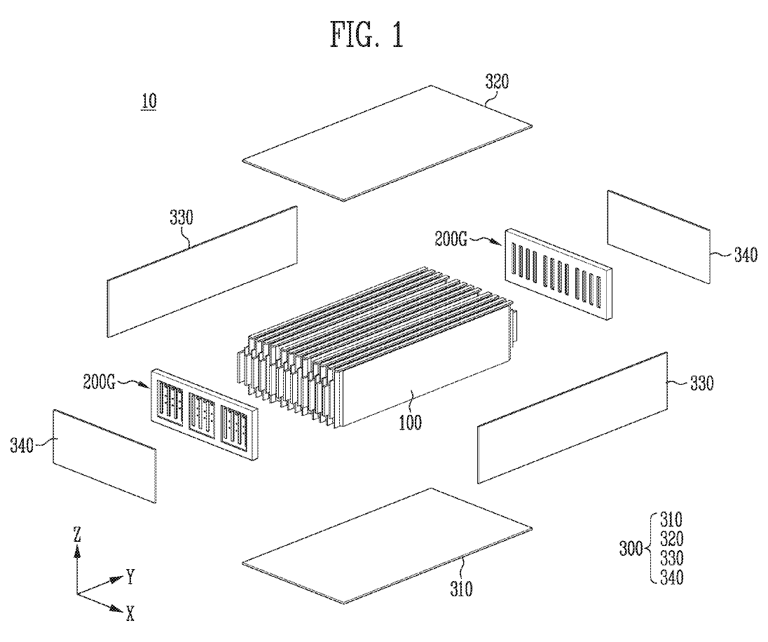

FIG. 1 illustrates a battery module 100 according to an embodiment.

As shown in FIG. 1, the battery module 10 according to an embodiment may include a battery cell 100, a busbar assembly 200G, and a case 300.

Meanwhile, in the present disclosure, the battery cell 100 may include a cell, a battery, a secondary battery, or a battery pack.

The battery cell 100 may be a secondary battery capable of repeatedly performing charging and discharging. The number of battery cells 100 may be plural. The battery cells 100 may be stacked in one direction. For example, the battery cells 100 may be stacked in the X-axis direction.

The battery cell 100 may include an electrode assembly, an outer casing, and electrode tabs 120. The outer casing may enclose the electrode assembly. The electrodes and electrode tabs 120 of the electrode assembly may be in contact with each other to form an electrical connection. The electrode tabs 120 may be electrically connected to the busbar assembly 200G. The electrode tabs 120 may protrude in a direction different from the stacking direction of the battery cell 100. For example, if the stacking direction is along the X-axis, the electrode tabs may protrude along the Y-axis.

The battery cell 100 may be of the pouch type. However, this is merely an embodiment, and the battery cell 100 may be modified to be of a cylindrical type, a prismatic type, or the like.

The busbar assembly 200G may be electrically connected to the electrode tabs 120 of the battery cell 100. For this purpose, the busbar assembly 200G and the electrode tabs 120 may be composed of a conductor with high electrical conductivity to allow electrical current to pass through.

The case 300 can accommodate the battery cell 100. In one embodiment, the case 300 may include a lower case 310, an upper case 320, an end plate 330, and side plates 340. The lower case 310 may be positioned at the bottom of the battery cell 100. The lower case 310 may support the battery cell 100. The upper case 320 may be positioned at the top of the battery cell 100. The end plate 330 may be positioned on one side of the battery cell 100. For example, when the battery cell 100 is stacked in the X-axis direction, the end plate 330 may be positioned at the two ends in the X-axis direction relative to the stacked battery cell 100. The side plate 340 may be positioned on another side of the battery cell 100. For example, when the battery cell 100 is stacked in the X-axis direction, the side plate 340 may be positioned at both ends in the Y-axis direction relative to the stacked battery cell 100.

In one embodiment, the lower case 310 may be manufactured as an integral part with the end plate 330 or the side plate 340. In one embodiment, the lower case 310 may be manufactured as a separate component from the end plate 330 or side plate 340. In this case, the lower case 310 may be coupled to the end plate 330 and side plate 340 using fastening members such as bolts or clamps. The upper case 320 may also be manufactured as an integral part of the end plate 330 or side plate 340, or as a separate component. In one embodiment, one or more one of the end plate 330 and side plate 340 may be omitted.

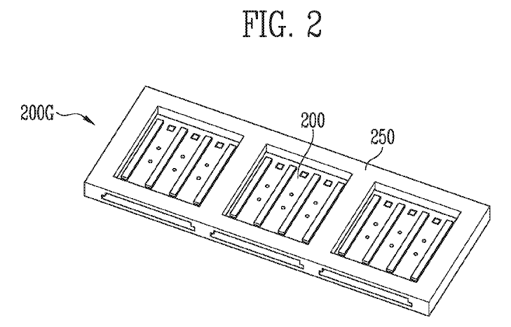

FIG. 2 illustrates a busbar assembly according to an embodiment.

In an embodiment, a busbar assembly 100 may comprise a plurality of busbars 200 each including one or more through holes 201 formed therein for inserting a plurality of electrode tabs 120, and a busbar frame 250 including a plurality of receiving portions 253 in a longitudinal direction, on which the plurality of busbars 200 are each mounted, wherein a bottom surface 250c of the receiving portion 253 includes one or more through holes 254 being opened at a position corresponding to the through holes 201 when the busbar 200 is mounted.

According to an embodiment, the busbar assembly 200G may include a plurality of busbars 200.

One of the multiple busbars 200 can electrically connect the battery cell 100 and an external device, while another busbar can electrically connect the battery cell 100 included in the battery module 10 and other battery cells included in the battery module 10.

In one embodiment, the plurality of busbars 200 may be manufactured as individual components. In another embodiment, the plurality of busbars 200 may be manufactured as a single component.

The busbar assembly 200G according to an embodiment may further include a busbar frame 250.

The multiple busbars 200 may be mounted on the busbar frame 250. The busbar frame 250 can fix the positions of the multiple busbars 200. In one embodiment, the busbar frame 250 can be made of various materials such as plastic or metal. The busbar frame 250 can be positioned between the multiple busbars 200 and the battery cells 100.

Meanwhile, in one embodiment, each of the multiple busbars 200 may have a through hole formed therein for inserting the electrode tabs of the battery cells 100. Additionally, the busbar frame 250 may have through holes formed at positions corresponding to the positions of the through holes of the busbars 200.

For example, a single busbar 200 may be formed by welding. That is, either a single busbar 200 may be formed by welding, or all of the multiple busbars 200 may be formed by welding.

The present disclosure provides a busbar assembly 200G with a new type of assembly structure. The following description, with reference to the additional drawings and subsequent explanations, provides a more detailed explanation of the new type of assembly structure of the present disclosure.

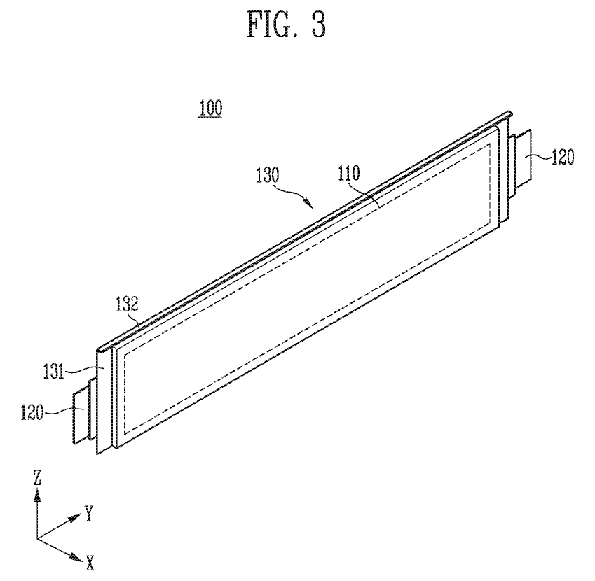

FIG. 3 illustrates a battery cell according to an embodiment.

Referring to FIG. 3, the battery cell 100 according to an embodiment may include an electrode assembly 110, an electrode tab 120, and an outer casing 130. The battery cell 100 according to an embodiment may be a pouch-type secondary battery. A pouch-type battery may be a secondary battery that uses a material with flexible or pliable characteristics as the outer casing 130.

The electrode assembly 110 may include electrodes, a separator, and an electrolyte. The electrodes may include a positive electrode and a negative electrode. The positive electrode and the negative electrode may be alternately stacked. A separator may be disposed between the positive electrode and the negative electrode.

The separator may prevent electrical contact between the negative electrode and the positive electrode. The separator may have pores formed therein to allow ions such as lithium ions to pass through. The electrolyte may include a material that functions as a medium to facilitate the movement of ions such as lithium ions.

The electrode tabs 120 may be connected to the electrodes of the electrode assembly 110. Specifically, the electrode tabs 120 may include an anode tab electrically connected to the anode of the electrode assembly 110 and a positive electrode tab electrically connected to the positive electrode of the electrode assembly 110. The electrode tabs 120 may protrude outward toward the exterior of the outer casing 130. For example, the positive electrode tabs may protrude in the +Y-axis direction, and the negative electrode tabs may protrude in the -Y-axis direction. For example, the material of each of the anode tab and cathode tab may be a conductive material such as copper or aluminum.

The outer casing 130 may enclose the electrode assembly 110. For example, the electrode assembly 110 may be accommodated in an internal space formed by the outer casing 130. In an embodiment, the outer casing 130 may be a pouch-type film. For example, the outer casing 130 may be an aluminum laminate film. Accordingly, the outer casing 130 may protect the electrode assembly 110.

The outer material 130 may include a sealing portion 131, 132. The sealing portion 131, 132 may be formed by bonding in various ways, such as adhesive bonding, heating, and pressing. The sealing portion 131, 132 may include a first sealing portion 131 and a second sealing portion 132. The second sealing portion 132 may be a folded portion of the first sealing portion 131.

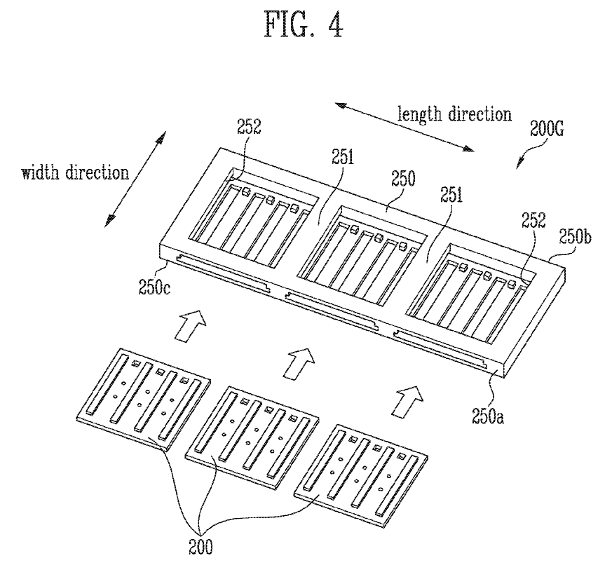

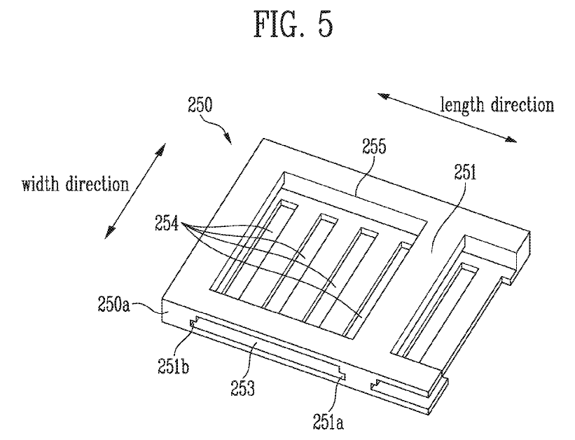

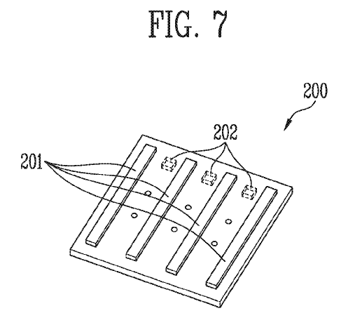

FIG. 4 illustrates the assembly of the busbar assembly according to an embodiment, FIG. 5 illustrates a busbar frame according to an embodiment, and FIG. 7 is a bottom view illustrating the busbar according to an embodiment.

Referring to FIGS. 4 and 5, the busbar assembly 200G according to one embodiment may include a plurality of busbars 200 having one or more one through hole 201 formed therein for inserting a plurality of electrode tabs 120, and a busbar frame 250 forming a plurality of receiving portions 253 arranged in the length direction.

In one embodiment, one or more through holes 254 may be formed at positions corresponding to the through holes 201 of the busbars 200 in a state where the multiple busbars 200 are mounted on the receiving portions formed on the busbar frame 250.

Referring to FIGS. 4, 5, and 7, for example, the busbar 200 may be a plate having a positive or negative polarity. The busbar 200 may be electrically connected to the battery cell 100. The busbar 200 may electrically connect other battery cells included in the same battery module 10 as the battery cell 100.

The busbar 200 may include one or more through holes 201. The through holes 201 of the busbar 200 may accommodate the electrode tabs 120 of the battery cell 100. For example, the electrode tabs 120 may be inserted into the through holes 201 and bent. The bent portion of the electrode tab 120 may come into contact with the surrounding area of the through hole 201 on the busbar 200. Through the contact area around the through hole 201, the busbar 200 may be electrically connected to the battery cell 100.

For example, when the electrode tab 120 is inserted into the through hole 201 and protrudes, the electrode tab 120 can be joined using laser welding or the like. In this case, the electrode tab 120 of the battery cell 100 can come into contact with the busbar 200. As a result, the battery cell 100 can be electrically connected to the busbar 200 through the electrode tab 120.

In the same manner, the busbar 200 can be electrically connected to other battery cells included in the battery module 10. Accordingly, the battery cell 100 can be electrically connected to other battery cells through the busbar 200.

For example, terminals can be formed on the busbar 200 to electrically connect to external devices. External devices refer to electronic devices or electrical devices outside the battery module 10. For example, external devices may include other battery modules, a battery management system, a vehicle, or other electronic devices.

For example, the busbar 200 and the busbar terminals may include one or more one of conductive materials such as copper, aluminum, or the like. For example, each of the busbar and the busbar terminals may be composed of a core containing copper, aluminum, or an alloy thereof, and a plating layer surrounding the core. The plating layer may include conductive materials such as nickel, tin, gold, or silver.

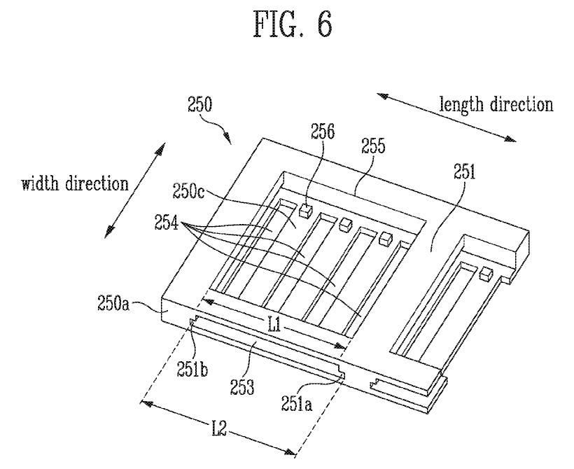

FIG. 6 is a perspective view illustrating the busbar frame 250 according to an embodiment.

In an embodiment, the busbar 200 may be inserted from the front 250a of the receiving portion 253 and mounted on the busbar frame 250.

Referring to FIGS. 4 to 6, the plurality of busbars 200 are each inserted from the front 250a of the busbar frame 250 and mounted on respective receiving portions 253 to be mounted on the busbar frame 250.

In an embodiment, the busbar frame may further include a plurality of walls 251 formed between each of the plurality of receiving portions 253, and the receiving portion 253 may be a slit.

For example, the receiving portions 253 of the busbar frame may be slits, and a plurality of walls 251 may be formed between each of the multiple slits 253.

In an embodiment, the wall 251 further may include a first guide groove 251a guiding a side of the busbar and extending in a width direction of the busbar frame 250. For example, each wall 251 may have a first guide groove 251a extending in the width direction of the busbar frame 250 while guiding one side or both sides of the busbar 200.

In an embodiment, the busbar frame 250 may further include a second guide groove 251b guiding a side of the busbar 200 on an inner side of the busbar frame and extending in a width direction of the busbar frame 250. For example, an inner wall a second guide groove 251b may be formed on the inner wall of the busbar frame 250 to guide one side of the busbar 200 while extending in the width direction of the busbar frame 250.

Therefore, during the process of inserting and mounting the busbar 200 into the slit 253 of the busbar frame 250, since the busbar 200 slides while being guided along the guide grooves 251a, 251b formed in the busbar frame 250, the busbar 200 can be easily inserted into the slit 253 of the busbar frame 250 and positioned correctly. Therefore, manufacturing efficiency can be increased.

In an embodiment, the busbar frame 250 may further include one or more openings being open to expose a portion of the busbars 200 mounted.

Referring to FIG. 6, the upper surface of the busbar frame 250 is open through the opening 255, allowing the operator to observe the process of the busbar 200 being slid and inserted into the busbar frame 250 or the state where the busbar 200 is mounted on the busbar frame 250.

In an embodiment, the length L1 of the opening 255 of the busbar frame 250 in the length direction may be smaller than the length L2 of the entire receiving portion 253 including the first guide groove 251a and the second guide groove 251b in the length direction. Therefore, when the busbar 200 is fully mounted on the busbar frame 250, the busbar 200 can be prevented from detaching from the upper surface of the busbar frame 250 through the opening 255 of the busbar frame 250.

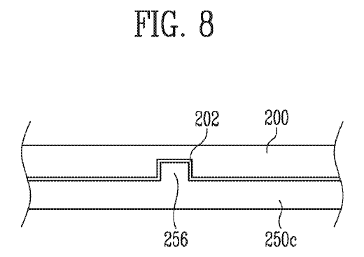

FIG. 8 is a sectional view illustrating the combination relationship between the busbar 200 and the busbar frame 250 according to an embodiment.

In an embodiment, the receiving portion 253 may further include a protrusion 253 protruding from the bottom surface 250c.

For example, the receiving portion 253 of the busbar frame 250 may further include a protrusion 256 that protrudes from the bottom surface 250c of the busbar frame 250. Referring to FIG. 6, the bottom surface 250c of the receiving portion 253 of the busbar frame 250 has a protrusion 256 formed thereon. The shape of the protrusion 256 may be formed as a rectangular prism, a cylindrical prism, a rectangular pyramid, or a conical pyramid.

In an embodiment, the busbar 200 may further include a groove 202 for receiving the protrusion 256.

For example, the busbar 200 may further include a groove 202 for receiving the protrusion 256. Referring to FIG. 7, at positions corresponding to the protrusions 256 of the busbar frame 250, the bottom surface 250c of the busbar 200 is formed with grooves 202 for receiving the protrusions 256. The shape of the groove 202 may be formed to correspond to the shape of the protrusions 256 to be received, and its size may be the same as or larger than the size of the shape of the protrusions 256 to be received.

Referring to FIG. 8, when the busbar 200 is mounted on the busbar frame 250, the protrusion 256 extending from the bottom surface 250c of the busbar frame 250 is completely received in the groove 202 formed in the busbar 200. Since the protrusion 256 of the busbar frame 250 restricts the movement of the busbar 200, the busbar 200 mounted on the busbar frame 250 can be prevented from detaching or falling out toward the front surface 250a of the busbar frame 250.

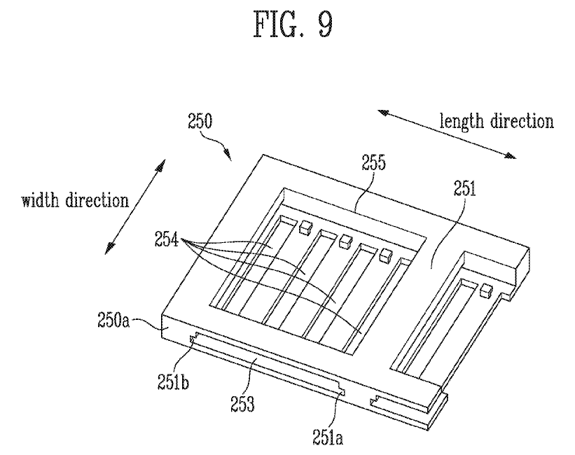

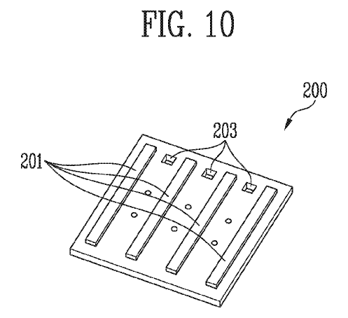

FIG. 9 illustrates a busbar frame 250 according to another embodiment, and FIG. 10 is a bottom view illustrating the busbar 200 according to another embodiment.

In another embodiment, the receiving portion 253 may further include a hook portion 257 protruding from the bottom surface 250c and being bent toward the rearward direction of the receiving portion 253.

For example, the receiving portion 253 of the busbar frame 250 may further include a hook portion that protrudes from the bottom surface 250c of the busbar frame 250 and is bent toward the rear surface 250b of the receiving portion 253. Referring to FIG. 9, the bottom surface 250c of the receiving portion 253 of the busbar frame 250 has a hook portion 257 formed so as to bend toward the rear surface 250b of the receiving portion 253. Referring to FIG. 9, the shape of the hook portion 257 is illustrated as a "ㄱ" shape, but it is sufficient for the protruding end of the hook portion 257 to bend toward the rear surface 250b of the busbar frame 250, and it is not necessarily limited to a "ㄱ" shape.

In another embodiment, the busbar 200 may further include an opening 203 through which the hook portion 257 passes.

For example, referring to FIG. 10, at the position corresponding to the hooking portion 257 of the busbar frame 250, the busbar 200 has an opening 203 through which the hooking portion 257 passes. The shape of the opening 203 may be formed to correspond to the shape of the hook portion 257 that it penetrates, and its size may be the same as or larger than the size of the shape of the hook portion 257 that it penetrates.

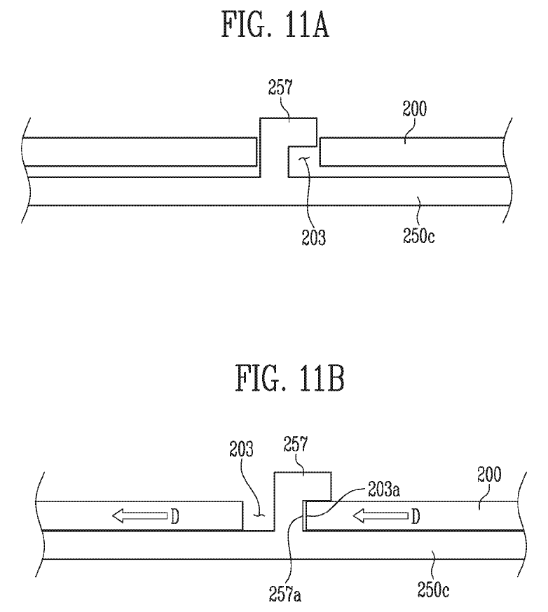

FIGS. 11A and 11B are cross-sectional views illustrating the combination relationship between the busbar and the busbar frame according to another embodiment.

Referring to FIGS. 11A and 11B, when the busbar 200 is mounted on the busbar frame 250, the hook portion 257 protruding from the bottom surface 250c of the busbar frame 250 passes through the opening 203 formed in the busbar 200. Even if the busbar 200 moves in the direction D away from the busbar frame 250, the movement of the busbar 200 is restricted by the one side 257a of the hook portion 257 of the busbar frame 250, thereby preventing the busbar 200 mounted on the busbar frame 250 from detaching or falling out toward the front surface 250a of the busbar frame 250. Additionally, the busbar 200 can be pressed toward the bottom surface 250c of the busbar frame 250 by the bottom surface of the hook portion 257.

With reference to the above description, those skilled in the art to which the present disclosure pertains will understand that the present disclosure may be implemented in other specific forms without changing the technical concept or essential features thereof.

The scope of the present disclosure is defined by the patent claims set forth below, rather than by the detailed description above, and all modifications or variations derived from the meaning, scope, and equivalent concepts of the patent claims shall be deemed to be included within the scope of the present disclosure.

What is claimed is:

1. A busbar assembly comprising:
a plurality of busbars each including one or more through holes formed therein for inserting a plurality of electrode tabs; and
a busbar frame including a plurality of receiving portions on which the plurality of busbars are each mounted,
wherein a bottom surface of the receiving portion includes one or more through holes being opened at a position corresponding to the through holes when the busbar is mounted.

2. The busbar assembly according to claim 1, wherein the busbar is inserted from the front of the receiving portion and mounted on the busbar frame.

3. The busbar assembly according to claim 1, wherein the busbar frame further includes a plurality of walls formed between each of the plurality of receiving portions.

4. The busbar assembly according to claim 3, wherein the wall further includes a first guide groove guiding a side of the busbar and extending in a width direction of the busbar frame.

5. The busbar assembly according to claim 1, wherein the busbar frame further includes a second guide groove guiding a side of the busbar on an inner side of the busbar frame and extending in a width direction of the busbar frame.

6. The busbar assembly according to claim 1, wherein the busbar frame further includes one or more openings being open to expose a portion of each mounted busbars.

7. The busbar assembly according to claim 6, wherein each length of the openings is smaller than a length in the length direction of the receiving portion.

8. The busbar assembly according to claim 1, wherein the receiving portion further includes a protrusion protruding from the bottom surface.

9. The busbar assembly according to claim 8, wherein the busbar further includes a groove for receiving the protrusion.

10. The busbar assembly according to claim 1, wherein the receiving portion further includes a hook portion protruding from the bottom surface and being bent toward the rearward direction of the receiving portion.

11. The busbar assembly according to claim 10, wherein the busbar further includes an opening through which the hook portion passes.

12. The busbar assembly according to claim 1, wherein the busbar includes a plate.

13. The busbar assembly according to claim 1, wherein the receiving portion includes a slit.
